(19) United States
(12) Patent Application Publication
(10) Pub. No.: US 2026/0362164 A1
(43) Pub. Date: Nov. 12, 2026

(54) METHOD, DEVICE, AND MEDIUM FOR PARAMETER DISCOVERY FOR OPTIMIZING PRIVATE NETWORKS

(71) Applicant: Verizon Patent and Licensing Inc., Basking Ridge, NJ (US)

(72) Inventors: Medha Joshi, Santa Clara, CA (US); Raghuram Parvataneni, Frisco, TX (US); Parry Cornell Booker, Sunnyvale, TX (US); Mahesh Chapalamadugu, Plano, TX (US)

(21) Appl. No.: 19/199,542

(22) Filed: May 6, 2025

(51) Int. Cl. H04W 24/02; H04W 12/02; H04W 28/02

(52) U.S. Cl. CPC H04W 24/02; H04W 12/02; H04W 28/0215

(57) ABSTRACT

A method, a network device, and a non-transitory computer-readable storage medium are described in relation to a parameter discovery service. A network device obtains an application performance profile that identifies target key performance indicators (KPIs) for running an application on a private wireless network. The network device collects, from multiple vendor equipment types associated with private wireless network, actual KPIs for operating the application that correspond to the target KPIs and performs a comparison of the actual KPIs to the target KPIs. The network device determines, based on the comparison, updated parameters for the private wireless network to meet the target KPIs and applies the updated parameters to the multiple vendor equipment types of the private wireless network.

### BACKGROUND

Development and design of networks present certain challenges from a network perspective and an end device perspective. With respect to Fourth Generation (4G) and Next Generation (NG) wireless networks, such as Fifth Generation New Radio (5G NR) networks, various mechanisms and technologies may be used to ensure the delivery of certain performance requirements, such as minimal latency and packet loss, as well as high throughput and other types of network performance criteria.

### BRIEF DESCRIPTION OF THE DRAWINGS

FIG. 1 is a diagram illustrating an exemplary environment in which an embodiment of a parameter discovery service may be implemented;

FIG. 2 is a diagram illustrating exemplary components for implementing the parameter discovery service;

FIG. 3 is a messaging diagram illustrating an exemplary process of an embodiment of the parameter discovery service;

FIG. 4 is a messaging diagram illustrating another exemplary process of an embodiment of the parameter discovery service;

FIG. 5 messaging diagram illustrating yet another exemplary process of an embodiment of the parameter discovery service;

FIG. 6 is a diagram illustrating exemplary components of a device that may correspond to one or more of the devices illustrated and described herein; and

FIG. 7 is a flow diagram illustrating an exemplary process of an embodiment of the parameter discovery service.

### DETAILED DESCRIPTION

The following detailed description refers to the accompanying drawings. The same reference numbers in different drawings may identify the same or similar elements. Also, the following detailed description does not limit the invention.

Private wireless networks continue to evolve, allowing use of a wide range of applications such as enterprise applications, real time gaming, augmented reality/virtual reality (AR/VR) streaming, mission-critical applications (e.g., industry 4.0 applications, such as supervisory control and data acquisition applications (SCADA); control applications for actuators, robots, autonomous guided vehicles (AGV); monitoring applications for wireless sensors), etc. These applications have diverse sets of requirements for performance and user experience. Currently, network slicing can be used in private networks based on the application requirements with static quality of service (QoS). Dynamic slicing using application programming interfaces (APIs) is on the horizon and is being developed. However, a crucial step for these APIs to work is discovery of application specific parameters for the private network.

Traditional methods of parameter discovery are manual, laborious, iterative, time consuming and can take many months in the lab. Traditional parameter discovery involves running various applications, identifying parameters that affect the key performance indicators (KPIs) for the desired performance, settings the parameters, benchmarking, measuring the performance, and iteratively repeating the process to achieve desired results. Another important factor in parameter discovery is vendor diversity and the accompanying technology variations which can result in the same parameters and/or parameter values not working the same (e.g., in terms of KPI performance, etc.) across different vendors. As the number of applications and supported vendors increase, the traditional methods of parameter discovery will not scale.

Implementations described herein provide an automatic, adaptive, closed loop parameter discovery service to support dynamic slicing in private wireless networks. The parameter discovery service may perform parameter discovery to optimize performance for multiple applications and multiple vendors. The parameter discovery service may use closed loop methodologies with continuous comparison of actual KPIs with target KPIs and automatic generation of private wireless network parameters that will result in the desired application performance. According to different implementations, the parameter discovery service may leverage generative artificial intelligence (AI) capabilities, reinforcement learning, multi-vendor KPI monitoring, and/or multi-vendor parameter setting techniques.

According to an implementation, a network device for the parameter discovery service obtains an application performance profile that identifies desired/target KPIs for running an application on a private wireless network. The network device collects, from multiple vendor equipment types associated with private wireless network, actual KPIs for operating the application that correspond to the desired/target KPIs and performs a comparison of the actual KPIs to the desired/target KPIs. The network device determines, based on the comparison, updated parameters for the private wireless network to meet the desired/target KPIs and applies the updated parameters to the multiple vendor equipment types of the private wireless network.

As used herein, “parameters” may refer to wireless network settings/configurations that affect KPIs for an application running on the wireless network. That is, a change in a parameter may result in a change in KPI values. For example, changing a radio parameter for Radio Link Control (RLC) Mode and a parameter for a Packet Data Convergence Protocol (PDCP) discard timer may increase/decrease a latency KPI. As another example, altering parameters for uplink (UL) and downlink (DL) component carrier sets may affect thermal/temperature KPIs for radio components.

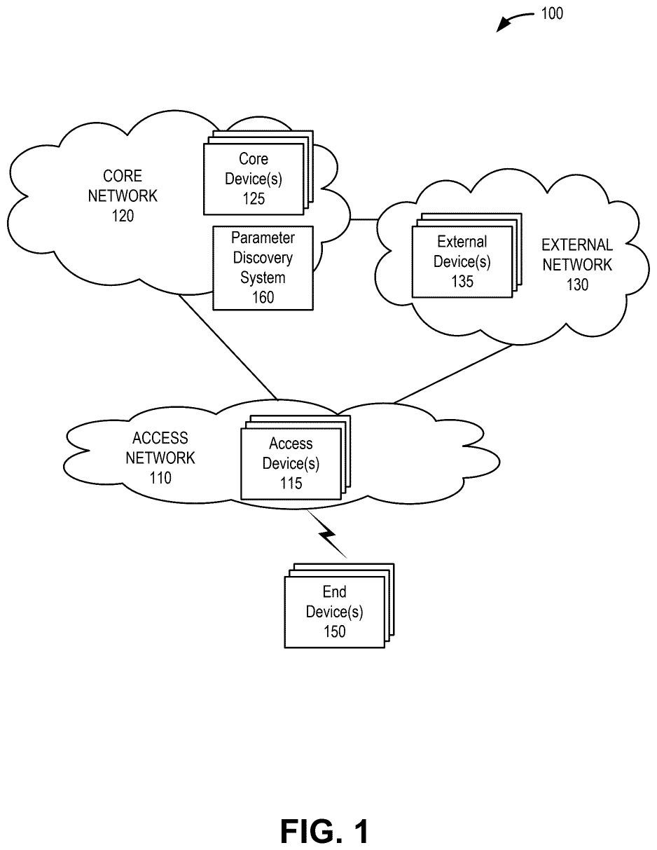

FIG. 1 is a diagram illustrating an exemplary environment 100 in which an embodiment of the parameter discovery service may be implemented. As illustrated, environment 100 includes an access network 110, a core network 120, and an external network 130. Access network 110 includes access devices 115 (also referred to individually or generally as access device 115). Core network 120 includes core devices 125 (also referred to individually or generally as core device 125). External network 130 includes external devices 135 (also referred to individually or generally as external device 135). Environment 100 further includes end devices 150 (also referred to individually or generally as end device 150) and a parameter discovery system 160.

The number, type, and arrangement of networks illustrated in environment 100 are exemplary. For example, according to other embodiments, environment 100 may include fewer networks, additional networks, and/or different networks. For example, according to other embodiments, other networks not illustrated in FIG. 1 may be included, such as an X-haul network (e.g., backhaul, mid-haul, fronthaul, etc.), a transport network, or another type of network that may support a wireless service and/or an end device application service, as described herein.

A network device, a network element (NE), or a network function (NF) (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, etc.), as well as used to support other types of network elements (e.g., network slices, QoS flows, network paths, tunnels, etc.). As described further herein, network devices configured to perform the same functions may be made by different vendors and use different (e.g., proprietary) vendor protocols.

Environment 100 includes communication links between the networks and between the network devices. Environment 100 may be implemented to include wired, optical, and/or wireless communication links. A communication link or connection may be direct or indirect. For example, an indirect communicative connection may involve an intermediary device and/or an intermediary network not illustrated in FIG. 1. A direct communication connection may not involve an intermediary device and/or an intermediary network.

Environment 100 may include various planes of communication including, for example, a control plane, a user plane, a service plane, and a network management plane. Environment 100 may include other types of planes of communication. A message communicated in support of the parameter discovery service may use at least one of these planes of communication. According to various implementations, the interface of the network device may be a service-based interface, a reference point-based interface, an Open Radio Access Network (O-RAN) interface, a 5G interface, another generation of interface (e.g., 5G Advanced, Sixth Generation (6G), Seventh Generation (7G), etc.), or some other type of network interface (e.g., proprietary, etc.).

Access network 110 may include one or multiple networks of one or multiple types and technologies. For example, access network 110 may be implemented to include a 5G RAN, a future generation RAN (e.g., a 6G RAN, a 7G RAN, etc.), a centralized-RAN (C-RAN), a virtualized RAN (vRAN), an Open-RAN (O-RAN), and/or another type of access network. Access network 110 may include a legacy RAN (e.g., a Third Generation (3G) RAN, a Fourth Generation (4G) RAN, etc.).

Access network 110 may include different and multiple functional splitting, such as options 1, 2, 3, 4, 5, 6, 7, or 8 that relate to combinations of access network 110 and core network 120 including an Evolved Packet Core (EPC) network and/or a Next Generation Core (NGC)/5G core network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), as well as other types of network services, such as dual connectivity (DC), carrier aggregation (CA), edge and core network slicing, coordinated multipoint (CoMP), various duplex schemes, and/or another type of connectivity service (e.g., NSA NR, SA NR, etc.).

Depending on the implementation, access network 110 may include one or multiple types of network devices, such as access devices 115. For example, access device 115 may include a gNB, an enhanced LTE (eLTE) eNB, an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN gNB, O-RAN-eNB), a 5G ultra-wide band (UWB) node, and/or a future generation wireless access device (e.g., a 5G advanced wireless station, a 6G wireless station, a 7G wireless station, or another generation of wireless station). Access devices 115 may include a transport device (e.g., a router or similar network device).

Core network 120 may include one or multiple networks of one or multiple network types and technologies. Core network 120 may include a complementary network of access network 110. For example, core network 120 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation, core network 120 may include diverse types of core devices 125. Core devices 125 may include, for example, an access and mobility management function (AMF), a session management function (SMF), a policy control function (PCF), a network exposure function (NEF), a unified data management (UDM) device, a unified data repository (UDR), a user plane function (UPF), a network slice selection function (NSSF), a network repository function (NRF), and/or a network data analytics function (NWDAF).

According to other implementations, core devices 125 may include additional, different, and/or fewer network devices than those described. For example, core devices 125 may include a non-standard or a proprietary network device, and/or another type of network device that may be well-known but not particularly mentioned herein. Core devices 125 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes. Also, core devices 125 may include a split core device 125. For example, core devices 125 may include a session management (SM) PCF, an access management (AM) PCF, a user equipment (UE) PCF, and/or another type of split architecture associated with another core device 125, as described herein.

External network 130 may include one or multiple networks of one or multiple types and technologies that provide an application service. For example, external network 130 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 130 may be implemented to include a cloud network, a private network, a public network, a Multi-access Edge Computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 130 may include various network devices, such as external devices 135. For example, external devices 135 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 150. Although not illustrated, external network 130 may include one or multiple types of core devices 125, as described herein.

External devices 135 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services.

End device 150 may include a device that may have communication capabilities (e.g., wireless, wired, optical, etc.). End device 150 may or may not have computational capabilities. End device 150 may be implemented as a mobile device, a portable device, a stationary device (e.g., a non-mobile device and/or a non-portable device), a device operated by a user, or a device not operated by a user. For example, end device 150 may be implemented as a smartphone, a mobile phone, a personal digital assistant, a tablet, a netbook, a wearable device, a computer, a gaming device, a music device, an Internet-of-Things (IoT) device, a drone, a smart device, an autonomous vehicle, or another type of wireless device (e.g., another type of UE). For purposes of description, end device 150 is not considered a network device.

In one implementation of environment 100, access network 110, core network 120, and external network 130 may represent a Public Land Mobile Network (PLMN). A service provider may manage a private wireless network for a subset of the PLMN subscribers. The private wireless network may include, for example, dedicated network elements to support certain levels of service. The subset of subscribers for the private wireless network may, for example, use end devices 150 equipped with subscriber credentials (e.g., a Subscriber Identity Module (SIM)) for accessing the private wireless network.

As further shown in FIG. 1, environment 100 may include a parameter discovery system 160. Parameter discovery system 160 may include one or more network devices that may implement aspects of the parameter discovery service, as described further herein. Although parameter discovery system 160 is depicted in core network 120 in FIG. 1, such an illustration is exemplary. According to other exemplary implementations, parameter discovery system 160 may reside in one or multiple networks depicted and described herein. Additionally, parameter discovery system 160 may be implemented in a centralized, distributed, and/or another type of network and/or computing architecture as a network device or system, as described herein.

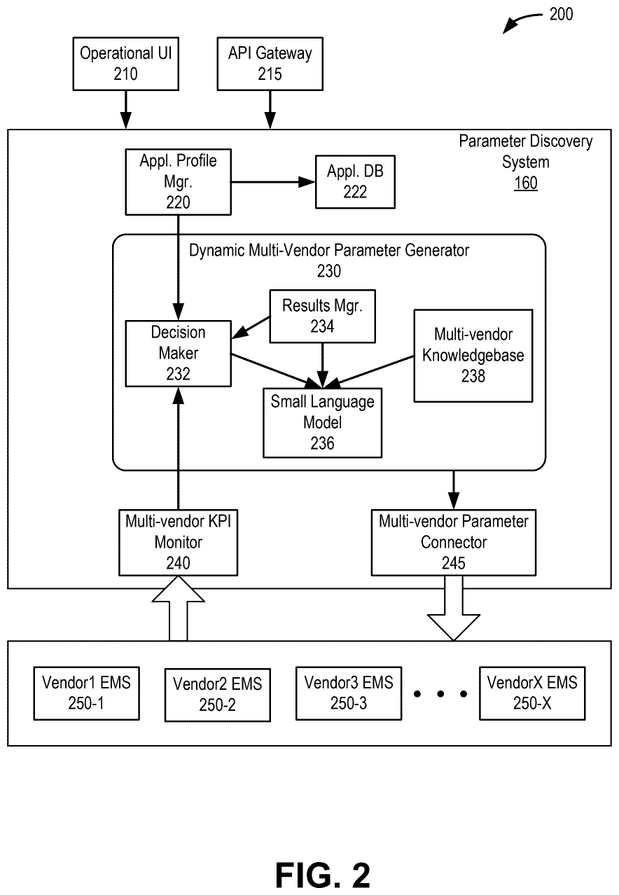

FIG. 2 is a diagram illustrating an exemplary portion 200 of environment 100 that may be used with the parameter discovery service. As shown in FIG. 2, portion 200 may include parameter discovery system 160 in communication with an operational user interface 210, an API gateway 215, and vendor Element Management System (EMS) functions 250. Parameter discovery system 160 may include an application profile manager 220, a dynamic multi-vendor parameter generator 230, a multi-vendor KPI monitor 240, and a multi-vendor parameter connector 245. In other implementations, each of operational user interface 210, API gateway 215, application profile manager 220, dynamic multi-vendor parameter generator 230, multi-vendor KPI monitor 240, and multi-vendor parameter connector 245 may be included within parameter discovery system 160. In other implementations, one or more elements of FIG. 2 may be included in another portion of network environment 100.

Operational user interface 210 may solicit/accept user input to define an application performance requirement (e.g., for a specific application using a private wireless network). The application performance requirement may represent the expected/desired performance criteria for the application. As an example, a user may define a performance profile for a particular application with a particular criterion for latency (e.g., less than about 20 mS), bandwidth (e.g., at least 10 mbps), jitter (e.g., less than about 5 mS), and network element temperature (e.g., radio (RU/RRU) temperature of 21 degrees Celsius). Other criteria may include packet loss, uplink throughput, downlink throughput, etc.

API gateway 215 allows exposure of APIs for the parameter discovery system 160 to other systems. For example, API gateway 215 may support APIs in parameter discovery system 160 for managing the application profiles, start/stop parameter discovery, reading generated parameters, and querying status of the closed loop system. API gateway 215 may, for example, support a machine-to-machine (M2M) interface for such APIs.

Application profile manager 220 may manage application profiles provided, for example, by users via operational user interface 210 and/or via API gateway 215. Application profiles may include application performance criteria expressed in terms of KPIs (e.g., latency, bandwidth, jitter, temperature, packet loss, uplink throughput, downlink throughput, etc.). In one embodiment, application profile manager 220 may implement CRUD (create, read, update, and delete) operations through which a user can create, read, update and delete application profiles. Application profile manager 220 may also manage data storage and retrieval of application profiles. For example, application profile manager 220 may use application database 222 for multiple application profiles. For each application profile, application database 222 may store the application profile KPIs (e.g., target KPIs), historic KPI data, and a closed loop discovery status (e.g., active/inactive) etc.

Dynamic multi-vendor parameter generator 230 may identify and generate parameters needed in a private wireless network to support target KPIs for an application (e.g., as indicated in the application performance profile). In one implementation, dynamic multi-vendor parameter generator 230 may include generative AI capabilities. According to an implementation, dynamic multi-vendor parameter generator 230 may include a decision maker 232, a results manager 234, a small language model 236, and a multi-vendor knowledgebase of KPIs and parameters 238.

Decision maker 232 may perform comparisons of target performance criteria and real-time KPI data for an application. Decision maker 232 may receive, for an application, an application profile (e.g., from application profile manager 220) with target performance criteria and real-time KPI data (e.g., from multi-vendor KPI monitor 240) with actual performance criteria. Decision maker 232 may take input from the multi-vendor KPI monitor 240 and application profile manager 220, compare the actual KPIs and target KPIs in real time, and feed the comparison results into small language model 236.

Results manager 234 may interface with decision maker 232 and small language model 236 to obtain the generated parameters, the status of the closed loop (e.g., active or inactive), and the error between actual and target KPIs. Results manager 234 may log results for responding to status requests (e.g., request submitted via user interface 210 or API gateway 215), including requests for reading generated parameters and querying status of the closed loop system.

Small language model 236 may include a deep learning model to identify parameters for meeting target KPIs on vendor systems. Small language model 236 may operate similarly to a large language model (LLM) or deep learning model that is initially trained on previously collected (e.g., training) data. Small language model 236 may have a smaller footprint than traditional LLMs, may operate with less resources (e.g., CPU, RAM, disk space, etc.), and may work well for a problem with narrow scope. In one implementation, small language model 236 may receive actual KPI vs. target KPI comparison results from decision maker 232. Based on the comparison results, small language model 236 may generate parameters (e.g., parameters that affect the KPIs for the desired performance) to more closely track the target KPIs.

Multi-vendor knowledgebase 238 may include data for specific vendor systems. For example, multi-vendor knowledgebase 238 may identify different vendor terminology, available parameters and device settings, hardware capabilities, software capabilities, and the like for similar systems made by different vendors. In one implementation, multi-vendor knowledgebase 238 may include a graph database to optimize the search of parameters. The data stored in the expert knowledgebase may be used, for example, by small language model 236 for analyzing historical patterns and for identifying relationships and/or trends where KPIs correspond to certain patterns of parameters.

Multi-vendor KPI monitor 240 may continuously monitor actual KPIs from a private wireless network (e.g., as reported by various vendor EMS functions 250). Multi-vendor KPI monitor 240 may function across all vendors of a private wireless network. In one implementation, multi-vendor KPI monitor 240 may be a multi-vendor component and work on a principle of factory design pattern, where an object is created without exposing the creation logic to the client and refers the newly created object using a common interface. Based on the vendor type, multi-vendor KPI monitor 240 may dynamically instantiate the type of monitor (from a group of different vendor type monitors) that interfaces with a vendor EMS function 250 to obtain real time KPIs.

Multi-vendor parameter connector 245 may apply generated settings to the private wireless network including settings with vendor EMS function 250. Multi-vendor parameter connector 245 may be responsible for setting the generated parameters by interfacing with the different vendor EMS functions 250. In one implementation, multi-vendor parameter connector 245 is a multi-vendor component and works on a principle of factory design pattern. Based on the vendor type, multi-vendor parameter connector 245 dynamically instantiates the correct type of parameter connector (e.g., with appropriate proprietary protocols for the particular vendor equipment type).

Vendor EMS function 250 may include a network element to manage the functions and capabilities of network elements for a particular vendor. Thus, each vendor may have a different vendor EMS function 250 to manage proprietary protocols, translations, etc. Network elements may include, for example, the implementation of certain network functions and at particular locations/sites within a private wireless network.

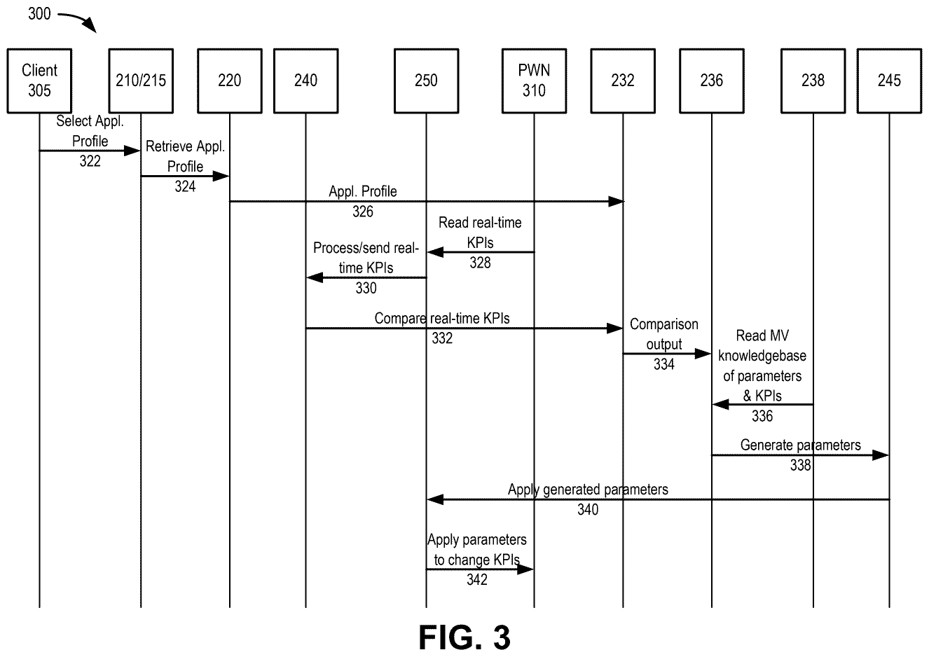

FIG. 3 is a messaging diagram illustrating an exemplary process 300 of an embodiment of the parameter discovery service. Process 300 describes messages relating to starting a closed loop for parameter discovery. As illustrated, process 300 may involve exemplary network devices, such as operational user interface 210/API gateway 215, application profile manager 220, decision maker 232, small language model 236, multi-vendor knowledgebase 238, multi-vendor KPI monitor 240, and multi-vendor parameter connector 245. Process 300 may further involve a client 305 and a private wireless network (PWN) 310. Client 305 may include a software application, which may be included, for example, in a computer workstation or an end device 150. Private wireless network 310 may be a specific subset of a PLMN in environment 100 for which parameter discovery is to be performed. According to other embodiments, process 300 may involve fewer, different, or additional network devices.

The messages illustrated and described are exemplary. Additionally, any protocol suggested by the form of a message is exemplary and not intended to limit the embodiment of the parameter discovery service. For example, some of the messages illustrated and described may include use of the Hypertext Transfer Protocol (HTTP) in which certain request methods (e.g., GET, POST, etc.) may be used. However, according to other embodiments, such messages may be implemented by a protocol other than HTTP or a version thereof. FIG. 3 provides simplified illustrations of communications and is not intended to reflect every signal or message exchanged between devices/functions.

Referring to FIG. 3, after an initial registration and/or attachment procedure (not shown), a user may use client 305 to select an application profile (with target KPIs) for parameter discovery. For example, client 305 may send a selection message 322 to operational user interface 210 and/or API gateway 215. Operational user interface 210/API gateway 215 may receive selection message 322 and, in response, direct application profile manager 220 to retrieve the corresponding application profile (e.g., from database 222, not shown). For example, operational user interface 210 or API gateway 215 may send a retrieve profile request 324 to application profile manager 220, including a unique application profile identifier. Application profile manager 220 may retrieve the application profile and send the application profile to decision maker 232 for eventual comparison of target KPIs with measured KPIs for the application. For example, application profile manager 220 may forward an application profile 326 to decision maker 232.

At some time after decision maker 232 receives application profile 326, private wireless network 310 may begin to report KPIs. For example, private wireless network 310 (e.g., access devices 115, core devices 125, and/or external devices 135) may send real-time KPIs 328 for the monitored application to a corresponding vendor EMS function 250. Each vendor EMS function 250 may process the real-time KPIs and forward them to multi-vendor KPI monitor 240, as indicated in KPI message 330.

Multi-vendor KPI monitor 240 may receive KPI message 330 and may process the real-time KPI data. In one implementation, multi-vendor KPI monitor 240 may convert the real-time KPI data from a vendor protocol into a standardized protocol for comparison purposes. Multi-vendor KPI monitor 240 may provide the processed real-time KPI data to decision maker 232. For example, multi-vendor KPI monitor 240 may send a processed KPI message 332 to decision maker 232 with the processed real-time KPI data. Decision maker 232 may receive KPI message 332 and compare the real-time (e.g., actual) KPIs with the target KPIs from application profile 326.

Decision maker 232 may compare the real-time KPIs with the target KPIs and provide the comparison results to small language model 236. For example, decision maker 232 may provide a comparison output message 334 to small language model 236.

In response to output message 334, small language model 236 may retrieve data from multi-vendor knowledgebase 238. For example, multi-vendor knowledgebase 238 may provide relevant knowledgebase data 336 to small language model 236. Relevant knowledgebase data 336 may include, for example, vender terminology, protocols, and associations for parameter that may impact the target KPIs.

Small language model 236 may apply knowledgebase data 336 from multi-vendor knowledgebase 238 to generate parameters 338. For example, small language model 236 may generate parameters that most closely correspond to achieving target KPI values. According to an exemplary embodiment, small language model 236 may use an optimization algorithm, such as a reinforcement learning algorithm or another type of learning algorithm (e.g., supervised learning, etc.) to minimize error in correlating the parameters and KPIs. The generated parameters 338 may be sent to multi-vendor parameter connector 245.

As shown at reference 340, multi-vendor parameter connector 245 may receive parameters 338 and send parameters 338 to vendor EMS function 250 (e.g., in the particular vendor's designated format/protocol). Vendor EMS function 250 may apply 342 the parameters to change the actual KPIs in private wireless network 310 to match the target KPIs from application profile 326. Process 300 may continue in closed-loop fashion, returning to reference number 328, where private wireless network 310 may continue to provide real-time KPIs.

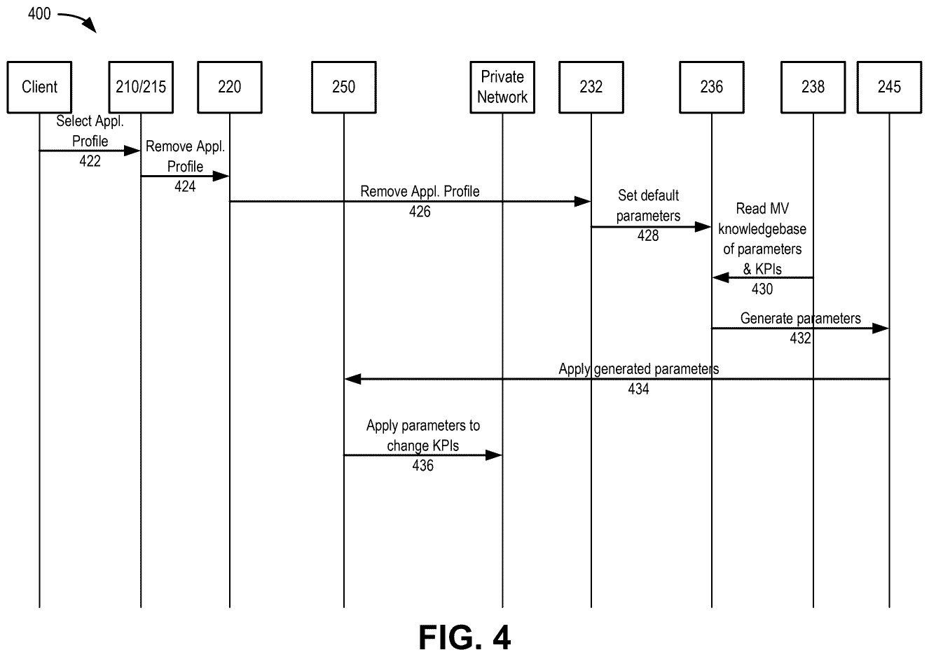

FIG. 4 is a messaging diagram illustrating an exemplary process 400 of another embodiment of the parameter discovery service. Process 400 describes messages relating to stopping a closed loop for parameter discovery. As illustrated, process 400 may involve exemplary network devices, such as operational user interface 210/API gateway 215, application profile manager 220, decision maker 232, small language model 236, multi-vendor knowledgebase 238, and multi-vendor parameter connector 245. Process 400 may further involve client 305 and private wireless network 310. According to other embodiments, process 400 may involve fewer, different, or additional network devices. FIG. 4 provides simplified illustrations of communications and is not intended to reflect every signal or message exchanged between devices/functions.

Similar to reference numbers 322 and 324 of process 300 above, a user may use client 305 to select an application profile 422 for discontinuing for parameter discovery and indicate the profile 424 to operational user interface 210 and/or API gateway 215. Operational user interface 210 or API gateway 215 may direct application profile manager 220 to remove the corresponding application profile from tracking/monitoring. For example, operational user interface 210 or API gateway 215 may send a remove profile request 424 to application profile manager 220, including a unique application profile identifier. Application profile manager 220 may send the application profile identifier to decision maker 232 for discontinuing parameter discovery. For example, application profile manager 220 may send a remove application profile message 426 to decision maker 232.

Decision maker 232 may receive remove application profile message 426 and, in response, will begin to ignore real-time KPIs from multi-vendor KPI monitor 240. Instead, decision maker 232 may send a signal to small language model 236 to return to default parameters for the application. For example, decision maker 232 may provide a set default parameters message 428 to small language model 236.

In response to set default parameters message 428, small language model 236 may retrieve data from multi-vendor knowledgebase 238. For example, multi-vendor knowledgebase 238 may provide relevant default parameters 430 to small language model 236. Small language model 236 receive the default parameters 430 from multi-vendor knowledgebase 238 and generate parameters 432. For example, small language model 236 may generate default parameter for the target KPI values. The generated default parameters 432 may be sent to multi-vendor parameter connector 245. As shown at reference 434, multi-vendor parameter connector 245 may receive the default parameters 432 and send default parameters 432 to vendor EMS function 250. Vendor EMS function 250 may apply 436 the default parameters.

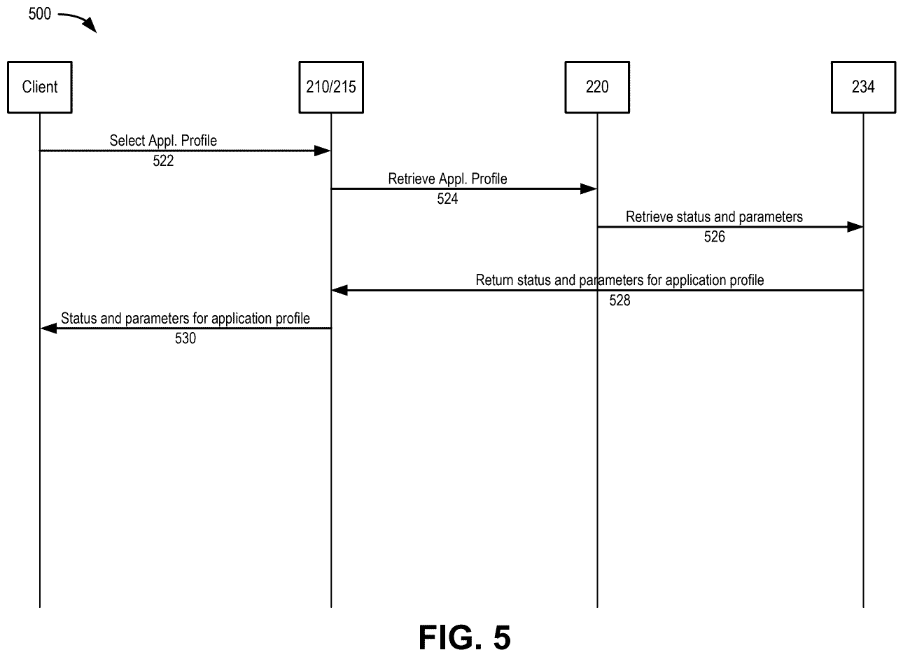

FIG. 5 is a messaging diagram illustrating an exemplary process 500 of yet another embodiment of the parameter discovery service. Process 500 describes messages relating to KPI reporting and/or updating an application performance profile. As illustrated, process 500 may involve exemplary network devices, such as operational user interface 210/API gateway 215, application profile manager 220, and results manager 234. Process 500 may further involve client 305. According to other embodiments, process 500 may involve fewer, different, or additional network devices. FIG. 5 provides simplified illustrations of communications and is not intended to reflect every signal or message exchanged between devices/functions.

A user may use client 305 to select an application profile for review (step 522) and indicate the profile to operational user interface 210 and/or API gateway 215. Operational user interface 210 or API gateway 215 may direct application profile manager 220 to retrieve (e.g., from database 222, not shown) the corresponding application profile for tracking/monitoring. For example, operational user interface 210 or API gateway 215 may send a retrieve profile request 524 to application profile manager 220, including a unique application profile identifier. Application profile manager 220 may send the application profile to results manager 234. For example, application profile manager 220 may a status message 526 for application profile to results manager 234.

Results manager 234 may assemble the generated parameters, a status of the closed loop, and any determined error between the actual and target KPIs. Results manager 234 may provide a report 528 to operational user interface 210/API gateway 215. As shown at reference 530, operational user interface 210/API gateway 215 may provide the report to client 305 for viewing by the user.

FIGS. 3-5 illustrate exemplary processes 300, 400, and 500; however, according to other embodiments and scenarios, these processes may include additional or fewer operations, and different operations, or a sub-combination thereof, and/or additional messages or fewer messages, and different messages, or a sub-combination thereof, depending on the context.

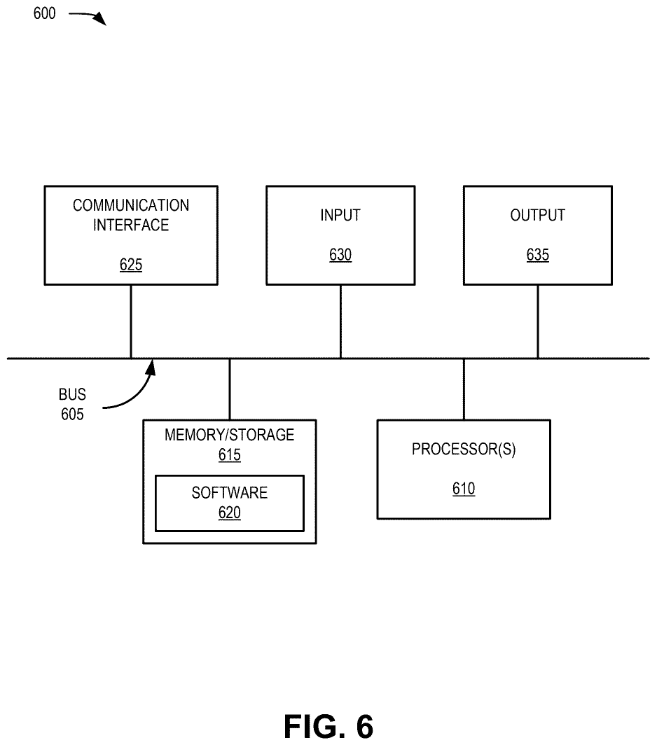

FIG. 6 is a diagram illustrating exemplary components of a device that may correspond to one or more of the devices illustrated and described herein. For example, device 600 may correspond to access device 115, core device 125, external device 135, end device 150, operational user interface 210, API gateway 215, application profile manager 220, dynamic multi-vendor parameter generator 230, multi-vendor KPI monitor 240, multi-vendor parameter connector 245, and vendor EMS function 250, and/or other types of devices, as described herein. As illustrated in FIG. 6, device 600 includes a bus 605, a processor 610, a memory/storage 615 that stores software 620, a communication interface 625, an input 630, and an output 635. According to other embodiments, device 600 may include fewer components, additional components, different components, and/or a different arrangement of components than those illustrated in FIG. 6 and described herein.

Bus 605 includes a path that permits communication among the components of device 600. For example, bus 605 may include a system bus, an address bus, a data bus, and/or a control bus. Bus 605 may also include bus drivers, bus arbiters, bus interfaces, clocks, and so forth.

Processor 610 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), quantum processors, future generation processors or execution environments, and/or some other type of component that interprets and/or executes instructions and/or data. Processor 610 may be implemented as hardware (e.g., a microprocessor, etc.), a combination of hardware and software (e.g., a SoC, an ASIC, etc.), may include one or multiple memories (e.g., cache, etc.), etc.

Processor 610 may control the overall operation, or a portion of operation(s) performed by device 600. Processor 610 may perform one or multiple operations based on an operating system and/or various applications or computer programs (e.g., software 620). Processor 610 may access instructions from memory/storage 615, from other components of device 600, and/or from a source external to device 600 (e.g., a network, another device, etc.). Processor 610 may perform an operation and/or a process based on various techniques and/or technologies including, for example, multithreading, parallel processing, pipelining, interleaving, machine learning, artificial intelligence, etc.

Memory/storage 615 includes one or multiple memories and/or one or multiple other types of storage mediums. For example, memory/storage 615 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory, a solid state memory, and/or some other type of memory. Memory/storage 615 may include a hard disk (e.g., a magnetic disk, an optical disk, a solid-state component, etc.), a Micro-Electromechanical System (MEMS)-based storage medium, and/or a nanotechnology-based storage medium.

Memory/storage 615 may be external to and/or removable from device 600, such as, for example, a Universal Serial Bus (USB) memory stick, a dongle, a hard disk, a solid state drive, mass storage, off-line storage, cloud storage, or some other type of storing medium. Memory/storage 615 may store data, software, and/or instructions related to the operation of device 600.

Software 620 includes an application or a program that provides a function and/or a process. As an example, with reference to dynamic multi-vendor parameter generator 230, software 620 may include an application that, when executed by processor 610, provides a function and/or a process of the parameter discovery service, as described herein. Additionally, with reference to application profile manager 220, multi-vendor KPI monitor 240, and/or other core devices 125, software 620 may include an application that, when executed by processor 610, configures processor 610 to provide a function and/or a process of the parameter discovery service or supports the process of the parameter discovery service, as described herein. Software 620 may also include firmware, middleware, microcode, hardware description language (HDL), and/or other form of instruction. Software 620 may also be virtualized. Software 620 may further include an operating system.

Communication interface 625 permits device 600 to communicate with other devices, networks, systems, and/or the like. Communication interface 625 includes one or multiple wireless interfaces, optical interfaces, and/or wired interfaces. For example, communication interface 625 may include one or multiple transmitters and receivers, or transceivers. Communication interface 625 may operate according to a protocol stack and a communication standard.

Input 630 permits an input into device 600. For example, input 630 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 635 permits an output from device 600. For example, output 635 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 600 may be implemented in the same manner. For example, device 600 may be instantiated, created, spun-up, uninstantiated, deleted, spun-down, or placed in some other operational state during its life cycle (e.g., refreshed, paused, suspended, rebooting, or another type of state or status), using well-known virtualization technologies. For example, access device 115, core device 125, external device 135, and/or another type of network device or end device 150, as described herein, may be a virtualized device.

Device 600 may perform a process and/or a function, as described herein, in response to processor 610 executing software 620 stored by memory/storage 615. By way of example, instructions may be read into memory/storage 615 from another memory/storage 615 (not shown) or read from another device (not shown) via communication interface 625. The instructions that are stored by memory/storage 615 may configure and cause processor 610 to perform a function or a process described herein. Alternatively, for example, according to other implementations, device 600 performs a function or a process described herein based on the execution of hardware (processor 610, etc.).

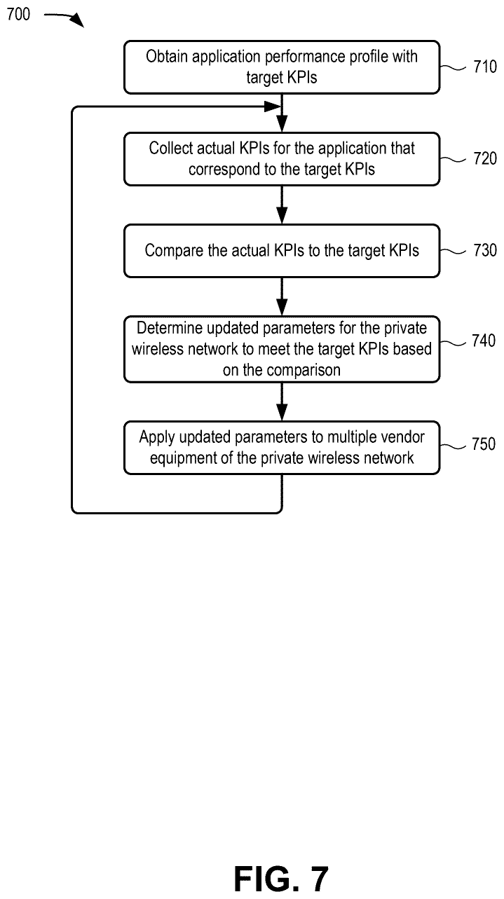

FIG. 7 is a flow diagram illustrating an exemplary process 700 of an embodiment of the parameter discovery service. According to an embodiment, dynamic multi-vendor parameter generator 230 may perform steps of process 700. According to an implementation, processor 610 executes software 620 to perform a step of process 700, as described herein. Alternatively, a step may be performed by execution of only hardware.

Process 700 may include obtaining an application performance profile that identifies target KPIs for operating an application on a private wireless network (block 710) and collecting actual KPIs for the application that correspond to the target KPIs (block 720). For example, based on a user selection (e.g., via operational user interface 210) or M2M instructions (e.g., via API gateway 215), application profile manager 220 may retrieve an application performance profile for an application running on a private wireless network. The application performance profile may identify multiple target KPIs associated with, for example, required network performance. Application profile manager 220 may provide the application performance profile to dynamic multi-vendor parameter generator 230. Dynamic multi-vendor parameter generator 230 may identify multiple vendor equipment types associated with private wireless network to support communications and tracking of parameters and KPIs for different vendor equipment. Different vendor EMS functions 250 associated with the private wireless network may continuously collect actual KPI readings for the application (e.g., in real time).

Process 700 may also include comparing the actual KPIs to the target KPIs (block 730). For example, dynamic multi-vendor parameter generator 230 (e.g., decision maker 232) may receive actual KPIs from vendor EMS functions 250 (e.g., via multi-vendor KPI monitor 240). Decision maker 232 may compare the real-time KPIs with the target KPIs and/or provide the comparison results to small language model 236.

Process 700 may additionally include determining updated parameters for the private wireless network (block 740) and applying the updated parameters to the private wireless network (block 750). For example, dynamic multi-vendor parameter generator 230 (e.g., small language model 236) may retrieve from multi-vendor knowledgebase 238 relevant knowledgebase data. Small language model 236 may apply knowledgebase data from multi-vendor knowledgebase 238 to generate parameters, such as parameters that most closely correspond to achieving target KPI values. Dynamic multi-vendor parameter generator 230 may provide the updated parameters to multi-vendor parameter connector, which may send the updated parameters to one or more of the multiple vendor EMS functions 250 (e.g., in the particular vendor's designated format/protocol). The vendor EMS functions 250 may apply the updated parameters to change the actual KPIs in the private network to match the target KPIs in the application profile. Process 700 may continue in a closed loop fashion, returning to block 720, to optimize the parameters to the target KPIs.

A method, a network device, and a non-transitory computer-readable storage medium are described in relation to a parameter discovery service. The parameter discovery service provides plug and play capabilities where users express desired application performance enabling fully automatic parameter discovery, saving significant time and expense over traditional open loop techniques. The parameter discovery service uses a closed loop technique with no human intervention, thus eliminating manual errors. The parameter discovery service provides for automatic scaling across multiple applications and multiple vendors, making private network optimization future proof. The parameter discovery service also provides a machine-to-machine interface to integrate with other network APIs for larger solutions.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations. The term “substantially” is used herein to represent a degree by which a quantitative representation may vary from a stated reference without resulting in a change in the basic function of the subject matter at issue.

In addition, while series of messages and blocks have been described regarding the processes illustrated in FIGS. 3-5 and 7, the order of the messages and blocks may be modified according to other embodiments. Further, non-dependent blocks may be performed in parallel. Additionally, other processes described in this description and illustrated in the drawings may be modified and/or non-dependent operations may be performed in parallel.

Embodiments described herein may be implemented in many different forms of software executed by hardware. For example, a process or a function may be implemented as “logic” or a “component.” The logic or the component may include, for example, hardware (e.g., processor 610, etc.), or a combination of hardware and software (e.g., software 620).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be used.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 610) of a device. A non-transitory storage medium includes one or more of the storage mediums described in relation to memory/storage 615. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later become known are expressly incorporated herein by reference and are intended to be encompassed by the claims.

What is claimed is:

1. A method comprising:
obtaining, by one or more network devices, an application performance profile that identifies target key performance indicators (KPIs) for running an application on a private wireless network;
collecting, by the one or more network devices and from multiple vendor equipment types associated with the private wireless network, actual KPIs for operating the application that correspond to the target KPIs;
performing, by the one or more network devices, a comparison of the actual KPIs to the target KPIs;
determining, by the one or more network devices and based on the comparison, updated parameters for the private wireless network to meet the target KPIs; and
applying, by the one or more network devices, the updated parameters to the multiple vendor equipment types of the private wireless network.

2. The method of claim 1, wherein the collecting includes:
dynamically instantiating a type of monitor, for the target KPIs, that interfaces with an Element Management System (EMS) for one of the multiple vendor equipment types.

3. The method of claim 1, wherein the collecting, performing, determining, and applying are performed in a closed loop.

4. The method of claim 1, wherein the collecting includes collecting the actual KPIs in real time, and
wherein the comparison includes comparing the actual KPIs to the target KPIs in real time.

5. The method of claim 1, wherein determining the updated parameters includes:
providing results of the comparison to a small language model that identifies the updated parameters that minimize error between the actual KPIs to the target KPIs.

6. The method of claim 1, wherein applying the updated parameters includes:
dynamically instantiating different types of parameter connectors to apply the updated parameters for each of the multiple vendor equipment types.

7. The method of claim 1, wherein obtaining the application performance profile includes:
providing a user interface to solicit the target KPIs for operating the application, or
receiving, via a machine-to-machine interface, the target KPIs for operating the application.

8. The method of claim 1, wherein the updated parameters define criteria for a network slice in the private wireless network.

9. A network device, comprising:
one or more processors that are configured to:
obtain an application performance profile that identifies target key performance indicators (KPIs) for running an application on a private wireless network;
collect, from multiple vendor equipment types associated with the private wireless network, actual KPIs for operating the application that correspond to the target KPIs;
perform a comparison of the actual KPIs to the target KPIs;
determine, based on the comparison, updated parameters for the private wireless network to meet the target KPIs; and
apply the updated parameters to the multiple vendor equipment types of the private wireless network.

10. The network device of claim 9, wherein, when collecting the actual KPIs, the one or more processors are further configured to:
dynamically instantiate a type of monitor, for the target KPIs, that interfaces with an Element Management System (EMS) for one of the multiple vendor equipment types.

11. The network device of claim 9, wherein the one or more processors are configured to perform the collecting, performing, determining, and applying in a closed loop.

12. The network device of claim 9, wherein, when collecting the actual KPIs, the one or more processors are further configured to:
collect the actual KPIs in real time.

13. The network device of claim 9, wherein, when determining the updated parameters, the one or more processors are further configured to:
apply results of the comparison to a small language model that identifies the updated parameters that minimize error between the actual KPIs to the target KPIs.

14. The network device of claim 9, wherein, when applying the updated parameters, the one or more processors are further configured to:
dynamically instantiate different types of parameter connectors to apply the updated parameters for each of the multiple vendor equipment types.

15. The network device of claim 9, wherein, when obtaining the application performance profile, the one or more processors are further configured to:
provide a user interface to solicit the target KPIs for operating the application, or
receive, via a machine-to-machine interface, the target KPIs for operating the application.

16. The network device of claim 9, wherein the updated parameters define criteria for a network slice in the private wireless network.

17. A non-transitory computer-readable storage medium storing instructions executable by a processor of an network device, wherein the instructions are configured for:
Obtaining an application performance profile that identifies target key performance indicators (KPIs) for running an application on a private wireless network;
collecting, from multiple vendor equipment types associated with private wireless network, actual KPIs for operating the application that correspond to the target KPIs;
performing a comparison of the actual KPIs to the target KPIs;
determining, based on the comparison, updated parameters for the private wireless network to meet the target KPIs; and
applying the updated parameters to the multiple vendor equipment types of the private wireless network.

18. The non-transitory computer-readable storage medium of claim 17, wherein the instructions for collecting further include instructions for:
dynamically instantiating a type of monitor, for the target KPIs, that interfaces with an Element Management System (EMS) for one of the multiple vendor equipment types.

19. The non-transitory computer-readable storage medium of claim 17, wherein the instructions for collecting, performing, determining, and applying are executed in a closed loop.

20. The non-transitory computer-readable storage medium of claim 17, wherein the updated parameters define criteria for a network slice in the private wireless network.
